(19) United States
(12) Patent Application Publication
(10) Pub. No.: US 2007/0008482 A1
(43) Pub. Date: Jan. 11, 2007

(54) EYEGLASSES

(76) Inventor: Wei-Che Teng, Wan Lee (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/160,812

(22) Filed: Jul. 11, 2005

(51) Int. Cl. G02C 5/00

(52) U.S. Cl. 351/41

(57) ABSTRACT

A pair of eyeglasses comprising a half-rim frame including a groove, and two cavities formed at its endpieces; a lens including two tabs at both ends, the tabs being adapted to snugly fit in the cavities; a nosepad including a flexible member and a soft member integrally formed around the flexible wherein the nosepad is threadedly secured to the frame; and two temples pivotably connected to the endpieces. The eyeglasses can be assembled quickly for mass production. Also, not only any of different individuals with different nose sizes may feel a degree of comfort when wearing the eyeglasses but also the eyeglasses are prevented from sliding down the nose of the wearer due to enhanced traction between the nosepad (i.e., the plastic member) and the nose of the wearer.

### BACKGROUND OF THE INVENTION

1. Field of Invention

The present invention relates to eyeglasses and more particularly to a pair of eyeglasses which are easy to combine/detach a lens to/from a frame and have a nosepad flexibly adjust with the sizes and shapes of different wearers' noses.

2. Related Art

How to quickly assemble one or two lenses with eyeglass frame is an important issue in eyeglass manufacturing industry. Conventionally, a snapping mechanism is implemented. However, its fastening may compromise after a short period time of use due to poor design.

Another issue with respect to eyeglasses is how to design a nosepad such that not only any of different individuals with different nose sizes may feel a degree of comfort when wearing a pair of eyeglasses but also the eyeglasses are prevented from sliding down the nose of the wearer due to enhanced traction between the nosepad and the nose of the wearer. Thus, continuing improvements in the exploitation of a pair of eyeglasses (e.g., sunglasses) achieving the above goals are constantly being sought.

### SUMMARY OF THE INVENTION

It is therefore an object of the present invention to provide a pair of eyeglasses comprising a frame, a lens, a nosepad secured to the back of a bridge of the frame, and two temples combined to both endpieces of the frame; wherein the frame is half-rim type and includes a groove formed along its upper portion for accommodating the upper portion of the lens, and two cavities formed at both end of the groove, tabs at both endpieces of the lens being respectively snapped into the cavities so as to combine the lens with the frame firmly.

It is another object of the present invention to provide a pair of eyeglasses comprising a frame, a lens, a nosepad, and two temples combined to both endpieces of the frame; wherein the nosepad includes a flexible member on the inner and a soft member on the outer so as to flexibly adjust with the sizes and shapes of different wearers' noses.

The above and other objects, features and advantages of the present invention will become apparent from the following detailed description taken with the accompanying drawings.

### BRIEF DESCRIPTION OF THE DRAWINGS

FIG. 1 is an exploded perspective view of a preferred embodiment of eyeglasses according to the invention;

FIG. 2 is a perspective view of the assembled eyeglasses in FIG. 1;

FIG. 3 is a side view in part section of the endpiece in FIG. 2; s

FIG. 4 is a side view in part section of the nosepad in FIG. 2; and

FIGS. 5 and 6 are front views of nosepad portion in FIG. 2 for illustrating an operating position thereof in response to a wearer wearing the eyeglasses and a normal position of the nosepad respectively.

### DETAILED DESCRIPTION OF THE INVENTION

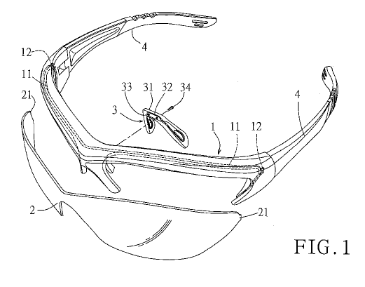

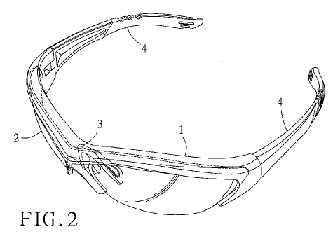

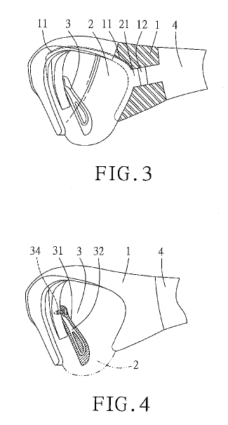

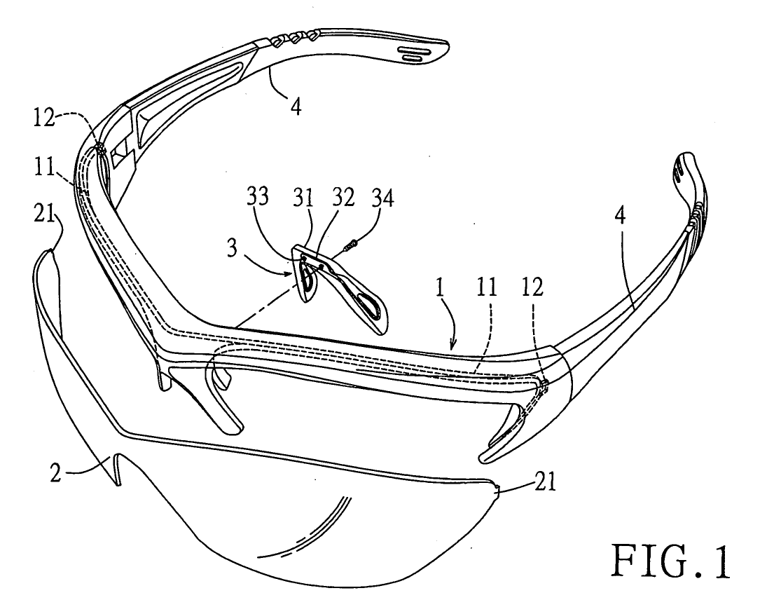

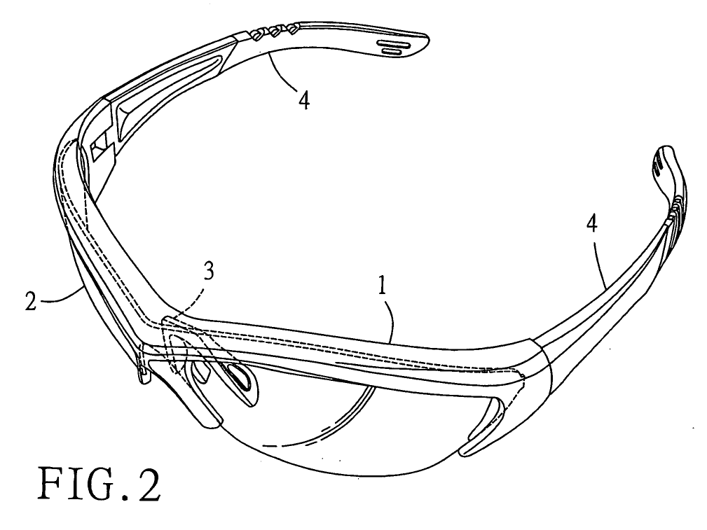

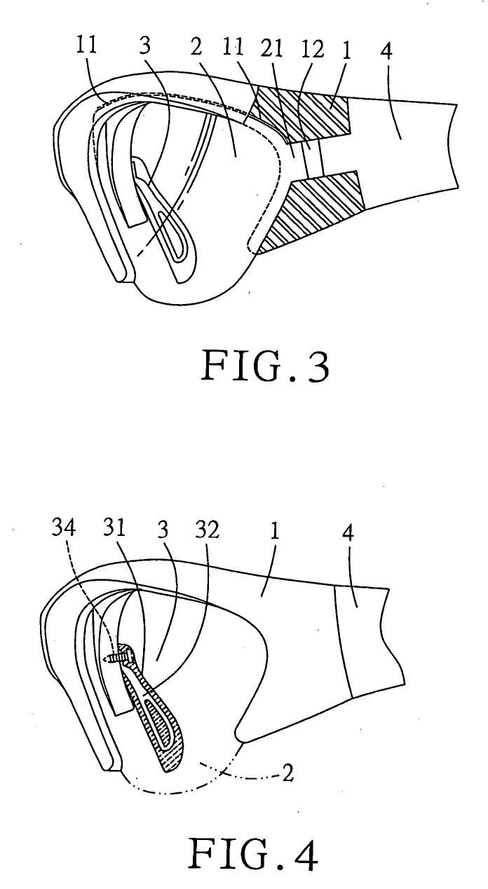

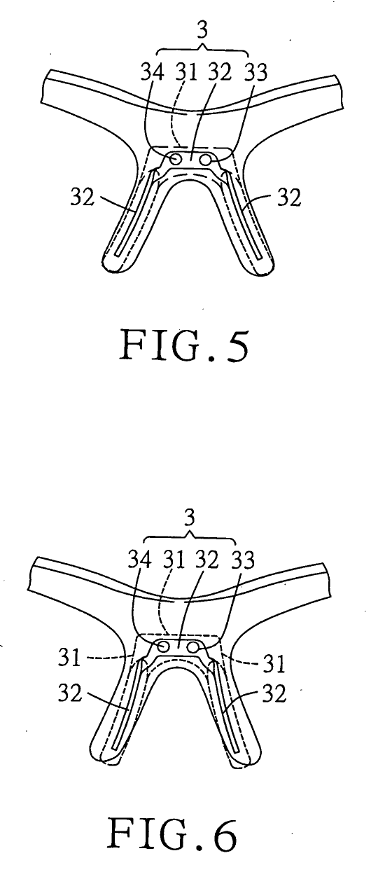

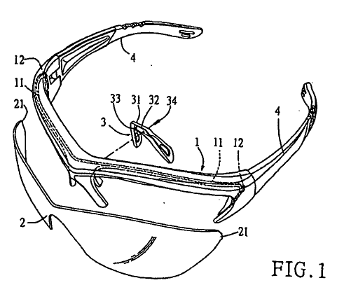

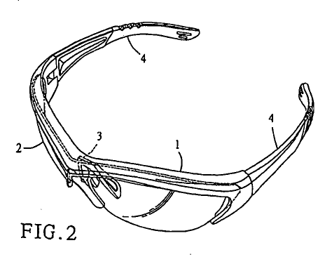

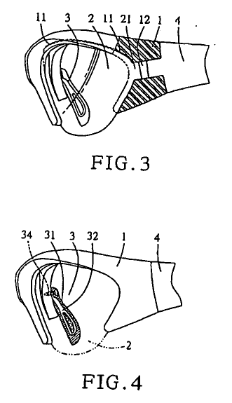

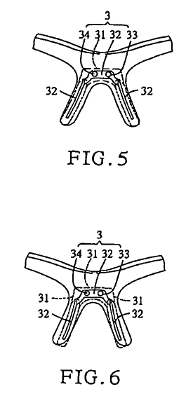

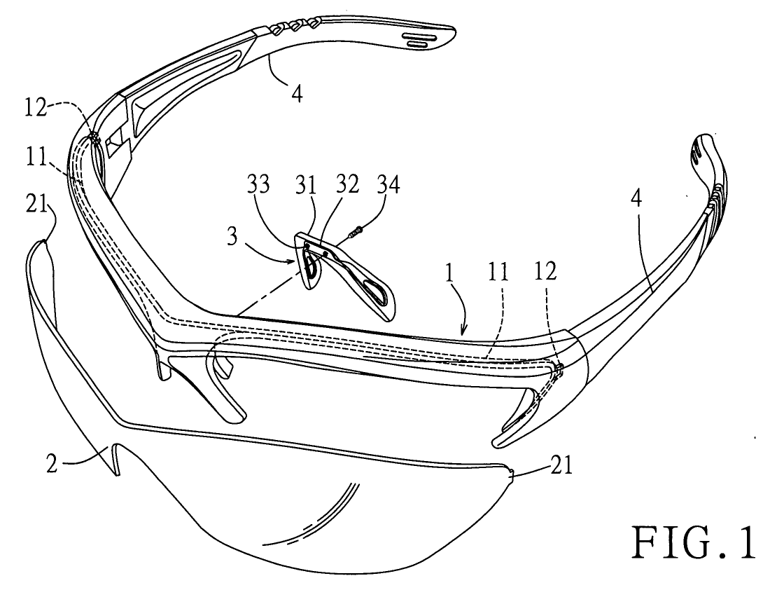

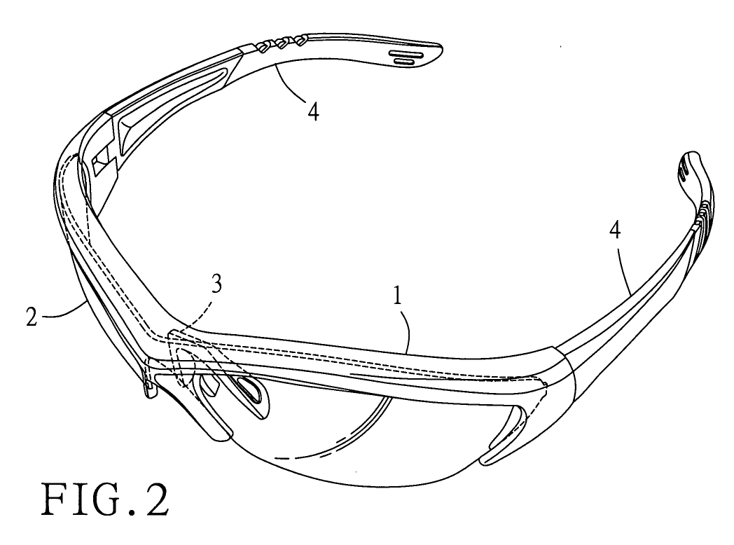

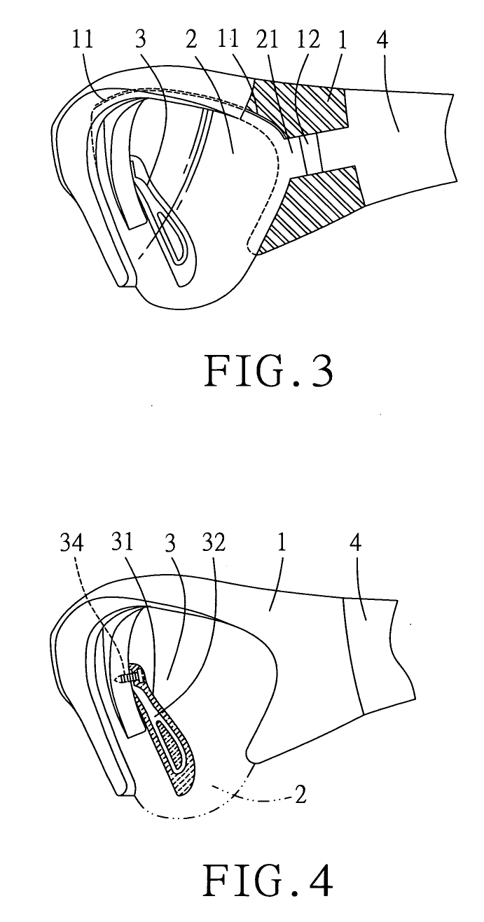

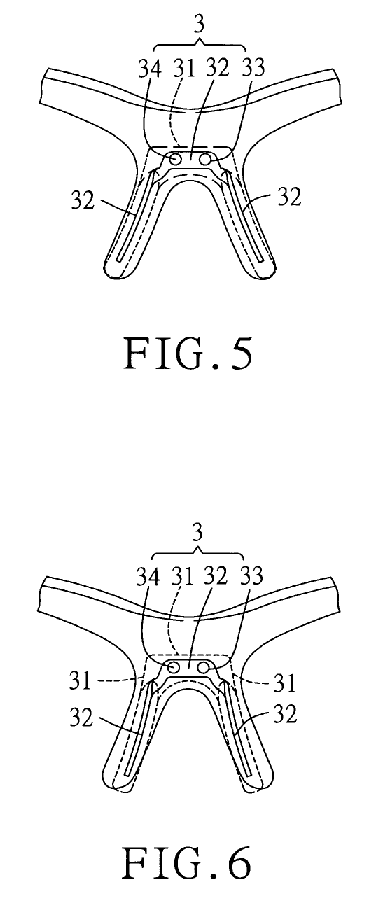

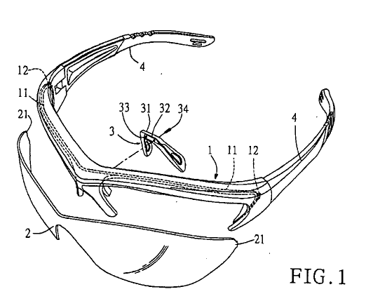

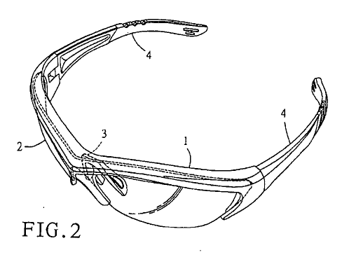

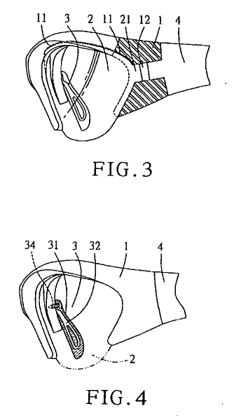

Referring to FIGS. 1 to 4, a pair of eyeglasses (e.g., sunglasses as shown) in accordance with a preferred embodiment of the invention comprise a half-rim frame 1, a lens 2, a nosepad 3, and two temples 4. The frame 1 includes a groove 11, and two cavities 12 at both end of the groove 11. The temples 4 are respectively combined to the endpieces of the frame 1. The lens 2 includes two tabs 21 at both ends snugly fit in the cavities 12. The nosepad 3 includes a flexible member 32 formed of elastic and deformable thin metal, a soft member 31 (e.g., rubber) integrally formed around the flexible member 32, two holes 33 at a joining portion of the middle section of the flexible member 32, and two fasteners (e.g., screws) 34 screwed through the holes 33 into a bridge of the frame 1 for securing the nosepad 3 to the frame 1.

In assembly, the upper portion of the lens 2 is inserted into the groove 11 inside the frame 1. Then, the tabs 21 at both endpieces of the lens 2 are respectively snapped into the cavities 12 at both ends of the groove 11 so that the lens are combined with the frame 1 firmly. Last, the nosepad 3 is secured to the back of the bridge of the frame 1 and the temples 4 are pivoted to both ends of the frame 1. Hereby, it is easy to combine the lens 2 to the frame 1 and/or detach the lens 2 from the frame 1.

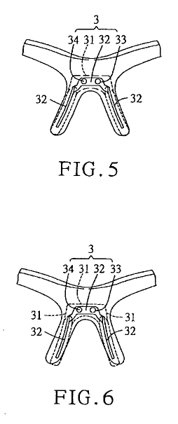

Referring to FIGS. 5 and 6, in response to a wearer wearing the eyeglasses the flexible member 32 flexibly adjusts with the size and shape of the wearer's nose as shown in FIG. 5. At the position of FIG. 5, not only any of different individuals with different nose sizes and shapes may feel a degree of comfort when wearing the eyeglasses due to the soft contact between the soft member 31 and the nose of the wearer but also the eyeglasses are prevented from sliding down the nose of the wearer due to enhanced traction between the soft member 31 and the nose of the wearer.

While the invention herein disclosed has been described by means of specific embodiments, numerous modifications and variations could be made thereto by those skilled in the art without departing from the scope and spirit of the invention set forth in the claims.

What is claimed is:

1. A pair of eyeglasses comprising a frame, a lens, a nosepad secured to the back of a bridge of the frame, and two temples combined to both endpieces of the frame; wherein the frame is half-rim type and includes a groove formed along its upper portion for accommodating the upper portion of the lens, and two cavities formed at both end of the groove, tabs at both endpieces of the lens being respectively snapped into the cavities so as to combine the lens with the frame firmly.

2. A pair of eyeglasses comprising a frame, a lens, a nosepad, and two temples combined to both endpieces of the frame; wherein the nosepad includes a flexible member on the inner and a soft member on the outer so as to flexibly adjust with the sizes and shapes of different wearers' noses.

3. The eyeglasses of claim 2; wherein the soft member is formed of rubber.

4. The eyeglasses of claim 2; wherein the flexible member is formed of elastic and deformable thin metal.

5. The eyeglasses of claim 2; wherein the soft member is integrally formed around the flexible member.

6. The eyeglasses of claim 2; wherein the nosepad is provided with two holes at a joining portion of the middle section for securing to the frame by fasteners.
